(19) United States
(12) Patent Application Publication
(10) Pub. No.: US 2026/0046811 A1
(43) Pub. Date: Feb. 12, 2026

(54) METHOD AND APPARATUS OF USER EQUIPMENT (UE) LOCATION ESTIMATION

(71) Applicant: LENOVO (BEIJING) LIMITED, Beijing (CN)

(72) Inventors: Congchi ZHANG, Shanghai (CN); Robin Rajan THOMAS, Bad Nauheim (DE); Mingzeng DAI, Shanghai (CN)

(21) Appl. No.: 19/100,361

(22) PCT Filed: Aug. 3, 2022
(86) PCT No.: PCT/CN2022/109949

§ 371 Date: Jan. 31, 2025

(51) Int. Cl. H04W 64/00

(52) U.S. Cl. CPC H04W 64/00

(57) ABSTRACT

Embodiments of the present application relate to a method and apparatus of user equipment (UE) location estimation. An exemplary method may include: sending a first message to an LMF associated with one or more BSs of a wireless network; receiving a second message from the LMF in response to sending the first message, wherein the second message at least includes information for determining an AI model for UE position estimation; and receiving the AI model as determined from the LMF.

### TECHNICAL FIELD

Embodiments of the present application are related to wireless communication technology, especially, related to artificial intelligence (AI) application in wireless communication, e.g., a method and apparatus of user equipment (UE) location estimation.

### BACKGROUND OF THE INVENTION

AI, at least including machine learning (ML) is used to learn and perform certain tasks via training neural networks (NNs) with vast amounts of data, which is successfully applied in computer vison (CV) and nature language processing (NLP) areas. Deep learning (DL), which is a subordinate concept of ML, utilizes multi-layered NNs as an “AI model” to learn how to solve problems and/or optimize performance from vast amounts of data.

By leveraging the advantage of AI, the performance of radio access network (RAN) network can be further optimized in at least the following use cases: energy saving, load balancing, traffic steering and mobility optimization. Thus, 3rd generation partnership program (3GPP) has been considering to introduce AI into 3GPP since 2016, including several study items and work items in SA1, SA2, SA5 and RAN3. However, there are still a mass of issues have not been discussed in 3GPP.

Taking UE location (or position) estimation as an example, in current 3GPP discussions related to AI based positioning, the industrial internet of things (IIoT) indoor factory (InF) scenario is a prioritized scenario for evaluation of AI based positioning, and a fingerprinting method is considered as an example using an AI model to estimate the UE position based on the wireless environment, e.g., the reference signal receiving power (RSRP) of associated reference signal(s). However, some problems, e.g., how can a UE acquire the AI model, e.g., used by the fingerprinting shall be solved.

Therefore, the industry needs a technical solution of UE location estimation, which is based on AI model from the core network (CN) side, e.g., location management function (LMF) and will improve AI application in further long-term evolution (LTE) of RAN.

### SUMMARY

One objective of the embodiments of the present application is to provide a technical solution for wireless communication, especially a technical solution of UE location estimation based on AI models.

Some embodiments of the present application provide a UE, which includes: a processor, and a transceiver coupled to the processor, wherein the transceiver is configured to: send a first message to an LMF associated with one or more base stations (BSs) of a wireless network; receive a second message from the LMF in response to sending the first message, wherein the second message at least includes information for determining an AI model for UE position estimation; and receive the AI model as determined from the LMF.

Some other embodiments of the present application provide an exemplary method, which can be performed in a UE. The exemplary method includes: sending a first message to an LMF associated with one or more BSs of a wireless network; receiving a second message from the LMF in response to sending the first message, wherein the second message at least includes information for determining an AI model for UE position estimation; and receiving the AI model as determined from the LMF.

In some embodiments of the present application, the first message is one of the following: a message indicating UE's support of AI based positioning estimation; a message of location service request; a message of request assistance data related to AI based positioning estimation; or a message of providing positioning related capabilities of the UE.

In some embodiments of the present application, the first message indicates at least one of the following: target scenario; preferred positioning method; or AI capability of the UE.

In some embodiments of the present application, the information for determining an AI model for UE position estimation includes information related to AI model transfer, and the information related to AI model transfer indicates at least one of the following: uniform resource location (URL) owned by the LMF or fully qualified domain name (FQDN) owned by the LMF, from that the AI model will be downloaded; type of learning method used by the AI model; type of the AI model; parameters related to the AI model; full payload of the AI model; or identity of the AI model. According to some embodiments of the present application, receiving the AI model from the LMF includes downloading the AI model from the URL or the FQDN via user plane protocol.

In some embodiments of the present application, the transceiver is configured to further receive information related to AI model application, and the information related to AI model application includes at least one of the following: information related to reference signals that will be measured and measurement results will be used as inputs to the AI model; information related to AI model validity concerning reference signals; information related to AI model validity concerning area; or information related to AI model validity concerning validity period.

According to some embodiments of the present application, in the case that the reference signals that will be measured are configured, the information related to AI model application includes information of determining whether the AI model is valid or not, wherein the information of determining whether the AI model is valid or not includes at least one of the following: at least one indicator, wherein each indicator is associated with a reference signal and indicates whether the reference signal needs to be detected; or at least one threshold, each threshold is that measured RSRP of one or more associated reference signals needs to be above or equal to.

According to some embodiments of the present application, the information related to AI model application is received before the AI model is downloaded from the LMF or is received after the AI model is downloaded from the LMF. For example, in the case that the information related to AI model application is received before the AI model is downloaded from the LMF, the information related to AI model application is also included in the second message. In the case that the information related to AI model application is received after the AI model is downloaded from the LMF, the transceiver is configured to transmit a message to request the information related to AI model application after downloading the AI model.

In some embodiments of the present application, in response to at least one problem detected during an AI model transfer procedure, the transceiver is configured to report at least one causes of the following to the LMF: an AI model download error; an AI model compliance error; or an AI model validity error.

In some embodiments of the present application, the transceiver is further configured to transmit at least one of the following to the LMF: information on common capabilities related to AI based positioning; or information on capabilities related to one or more specific AI based positioning methods. Exemplary information on common capabilities related to AI based positioning includes at least one of the following: an indicator implying maximum complexity or maximum size or maximum computation power of the AI model that is supported by the UE; maximum floating-point operations per second (FLOPS) that is supported by the UE; inference latency achieved by the UE when using a reference AI model; or a maximum number of AI models that the UE can store. Exemplary information on capabilities related to one or more specific AI based positioning methods includes at least one of the following: supported band(s); supported frequency(s); supported bandwidth(s); a maximum number of frequency layers supported by the UE; or a maximum number of reference signals processed by the UE in a slot.

Some embodiments of the present application provide an LMF, which includes: a processor; and a transceiver coupled to the processor, wherein the transceiver is configured to: receive a first message from a UE; transmit a second message to the UE in response to receiving the first message, wherein the second message at least includes information for determining an AI model for UE position estimation; and transmit the AI model as determined to the UE.

In some embodiments of the present application, the transceiver is configured to further transmit information related to AI model application to the UE, and the information related to AI model application includes at least one of the following: information related to reference signals that will be measured and measurement results will be used as inputs to the AI model; information related to AI model validity concerning reference signals; information related to AI model validity concerning area; or information related to AI model validity concerning validity period.

According to some embodiments of the present application, the information related to AI model application is transmitted before the AI model is downloaded by the UE from the LMF or is transmitted after the AI model is downloaded by the UE from the LMF. In the case that the information related to AI model application is transmitted before the AI model is downloaded by the UE from the LMF, the information related to AI model application is also included in the second message. In the case that the information related to AI model application is transmitted after the AI model is downloaded by the UE from the LMF, the transceiver is configured to: receive a message to request the information related to AI model application after the AI model is downloaded; and transmit the information related to AI model application in response to receiving the message.

In some embodiments of the present application, the transceiver is configured to receive at least one cause of the following from the UE, each cause indicates a problem detected during an AI model transfer procedure: an AI model download error; an AI model compliance error; or an AI model validity error.

In some embodiments of the present application, the transceiver is further configured to transmit a message to request information on positioning related capabilities of the UE and receive the information on positioning related capabilities of the UE, wherein the information on positioning related capabilities of UE includes at least one of the following: information on common capabilities related to AI based positioning; or information on capabilities related to one or more specific AI based positioning methods.

In some embodiments of the present application, payload of the AI model is transmitted to the UE via user plane protocol.

Given the above, embodiments of the present application propose a technical solution of UE location estimation, wherein an AI model for UE location estimation can be downloaded from the CN side via user plane protocol so that AI based positioning can be implemented, which will improve the accuracy of UE location estimation and facilitate the implementation of AI-based RAN.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 is a schematic diagram illustrating an exemplary wireless communication system according to some embodiments of the present application.

FIG. 2 illustrates an exemplary architecture of a 5G system with location related functions according to some embodiments of the present application.

FIG. 3 is a flow chart illustrating an exemplary procedure of a method of UE location estimation according to some embodiments of the present application.

FIG. 4 illustrates an exemplary procedure of a method of UE location estimation according to some embodiments of the present application.

FIG. 5 illustrates another exemplary procedure of a method of UE location estimation according to some other embodiments of the present application.

FIG. 6 illustrates a block diagram of an apparatus of UE location estimation according to some embodiments of the present application.

FIG. 7 illustrates a block diagram of an apparatus of UE location estimation according to some other embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, and so on. It is contemplated that along with the developments of network architectures and new service scenarios, all embodiments in the present application are also applicable to similar technical problems. Moreover, the terminologies recited in the present application may change, which should not affect the principle of the present application.

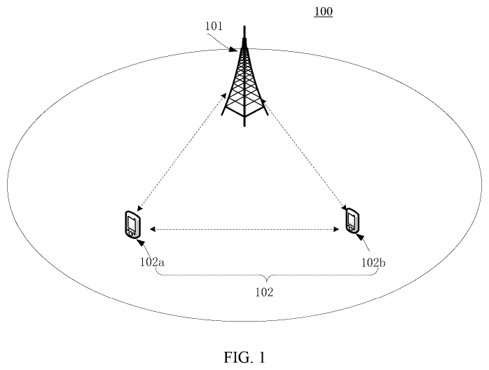

FIG. 1 illustrates a schematic diagram of an exemplary wireless communication system 100 according to some embodiments of the present application.

As shown in FIG. 1, the wireless communication system 100 includes at least one BS 101 and at least one UE 102. In particular, the wireless communication system 100 includes one BS 101 and two UE 102 (e.g., a first UE 102a and a second UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a CN node (not shown), e.g., a mobility management entity (MME) or a serving gateway (S-GW), a mobility management function (AMF), a user plane function (UPF), or an LMF etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

The UE 102, e.g., the first UE 102a and second UE 102b should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

In legacy, depending on wireless communication deployments and scenarios, UE location estimation can be done in either UE side or LMF side.

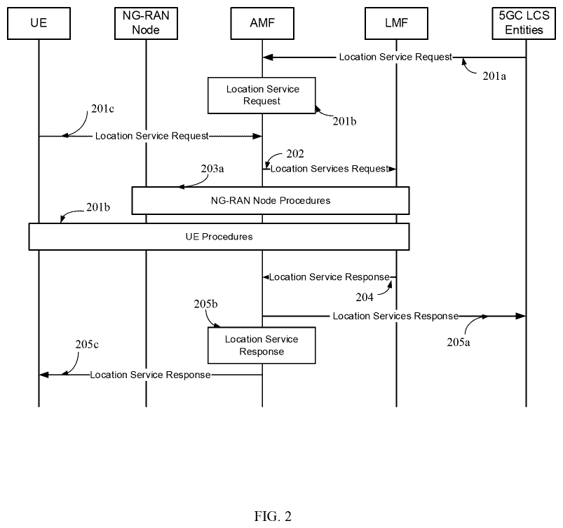

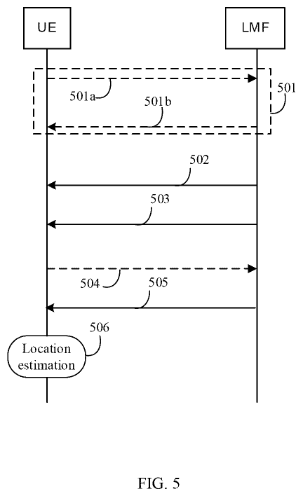

For example, to support positioning of a target UE and delivery of location assistance data to a UE with NG-RAN access in 5G system (5GS), location related functions are distributed as shown in the architecture in FIG. 2, which is consistent with FIGS. 5.1-1 in TS 38.305 and as clarified in greater detail in TS 23.501 [2] and TS 23.273 [35]. The overall sequence of events applicable to the UE, NG-RAN and LMF for any location service is shown in FIG. 2 as follows.

First, location services will be requested for a target UE to the LMF. For example, either, some 5GC location service (LCS) entities (e.g. gateway mobile location center (GMLC)) request some location services (e.g. positioning) for the target UE to the AMF (e.g., the serving AMF) in step 201a. Or, in step 201b, the AMF for the target UE determines the need for some location services (e.g. to locate the UE for an emergency call). Or, in step 201b, the target UE requests some location services (e.g. positioning or delivery of assistance data) to the AMF at the non-access stratum (NAS) level.

Note that when the AMF receives a location service request in the case of the UE is in connection management (CM)-IDLE state, the AMF performs a network triggered service request as defined in TS 23.502 and TS 23.273 in order to establish a signaling connection with the UE and assign a specific serving gNB or ng-eNB. The UE is assumed to be in connected mode before the beginning of the flow shown in FIG. 2; that is, any signaling that might be required to bring the UE to connected mode prior to step 201a is not shown. The signaling connection may, however, be later released (e.g., by the NG-RAN node as a result of signaling and data inactivity) while positioning is still ongoing.

In step 202, the AMF transfers the location service request to an LMF.

In step 203a, the LMF instigates location procedures with the serving and possibly neighbouring ng-eNB or gNB in the NG-RAN, e.g., to obtain positioning measurements or assistance data.

In addition to step 203a or instead of step 203a, the LMF instigates location procedures with the UE in step 203b, e.g., to obtain a location estimation or positioning measurements or to transfer location assistance data to the UE.

In step 204, the LMF provides a location service response to the AMF and includes any needed results, e.g. success or failure indication and, if requested and obtained, a location estimation for the UE.

In step 205a, if step 201a was performed, the AMF returns a location service response to the 5GC entity in step 201a and includes any needed results, e.g. a location estimation for the UE.

In step 205b, if step 201b occurred, the AMF uses the location service response received in step 204 to assist the service that triggered this in step 201b (e.g. may provide a location estimation associated with an emergency call to a GMLC).

In step 205c, if step 201c was performed, the AMF returns a location service response to the UE and includes any needed results, e.g. a location estimation for the UE.

When AI is introduced into 3GPP, in some scenarios, AI based UE location estimation is possible in the UE side. For example, in an IIOT scenario, e.g., INF, a UE may be a robot moving around. It would be great helpful to improve the positioning accuracy if the UE is capable of performing position estimation using an AI model, e.g., by fingerprinting based on channel observation as the input of the AI model. However, in legacy UE based 5G positioning, the UE estimates its own position using assistance data received from the LMF via an LPP message(s), which is designed to transfer control plane messages of size up to 1 MB. Since a size of an AI model may be up to 100 MB, which is much higher than 1 MB, how can the UE acquire the AI model for UE position estimation (or a positioning AI model) needs to be solved.

At least considering the above problem, embodiments of the present application provide a technical solution of UE location estimation, which is based on an AI model transferred from the CN side. For example, some embodiments of the present application provide a method and apparatus of UE location estimation, wherein an AI model transferred (or transmitted) from the CN, e.g., from the LMF via the user plane protocol is used for UE location estimation. The AI model transfer procedure can be triggered due to a solicited message, which may be based on a UE's request, e.g., LPP RequestAssistanceData message or an unsolicited message, which may be based on the LPP ProvideAssistanceData message. The AI model, e.g., AI model for fingerprinting, can be trained by the LMF or other wireless apparatus using data collected from UE, e.g., a set of ground truth position and the measured RSRP at each ground truth position. Herein, it is assumed that the AI model has been trained and stored in the LMF.

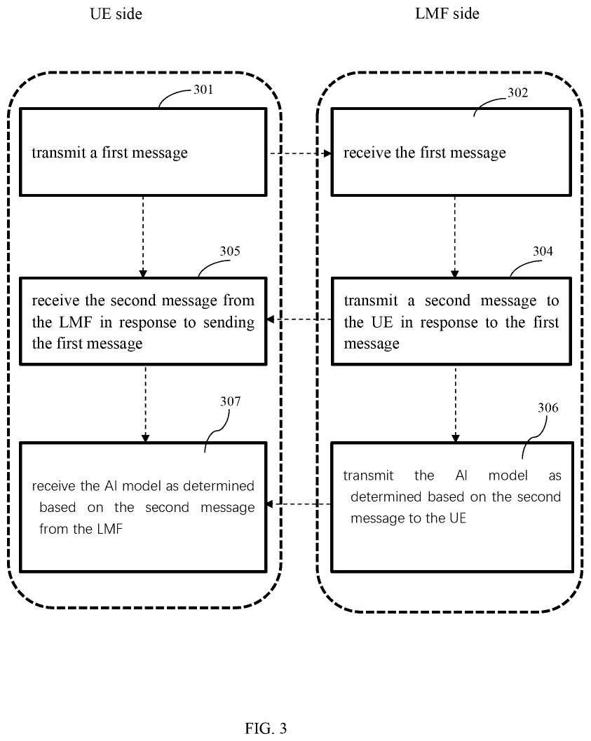

FIG. 3 is a flow chart illustrating an exemplary procedure of a method of UE location estimation according to some embodiments of the present application. Although the method is illustrated in a system level by a remote apparatus, e.g., a UE 102 as shown in FIG. 1 and a CN function entity, e.g., an LMF, persons skilled in the art can understand that the method implemented in the UE and that implemented in the LMF can be separately implemented and incorporated by other apparatus with the like functions.

Referring to FIG. 3, an AI model related to UE location estimation will be requested for the UE from the LMF, which can be achieved in various manners. For example, in step 301, the UE will send a first message to an LMF, e.g., via an AMF similar to that illustrated in FIG. 2, wherein the LMF may be associated with one or more BSs, e.g., the serving BS of the UE. The first message is various, and may indicate at least one of the following: target scenario, preferred positioning method (e.g., fingerprinting), or AI capability of the UE. For example, the first message may be a message indicating UE's support of AI based positioning estimation. In another example, the first message is a message of location service request, e.g., a NAS message of Location Service Request. In yet another example, the first message is a message of request assistance data related to AI based positioning estimation, e.g., an LPP message of RequestAssistanceData. In yet another example, the first message is a message of providing positioning related capabilities of the UE. In the case that the UE transmits the first message to the LMF via the AMF, the AMF can also select the LMF based on the first message.

Regarding the target area, it may be a geographical area as specified in TS 23.273. For example, the target area is expressed as one of the following format, if needed: a) a shape defined in TS 23.032; b) local coordinate system for LCS Client, e.g. using the open mobile alliance (OMA) mobile location protocol (MLP) protocol; c) E.164 country code for a geographic area for LCS Client e.g. using the OMA MLP protocol; d) public land mobile network (PLMN) identity for LCS Client e.g. using the OMA MLP protocol; and e) geopolitical name of the area (e.g. London) for LCS Client, e.g. using the OMA MLP protocol.

Regarding the AI capability of the UE, it may include positioning related capabilities of the UE, e.g., common capabilities related to AI based positioning and capabilities related to one or more specific AI based positioning methods (e.g., fingerprinting). Exemplary information on common capabilities related to AI based positioning may include at least one of the following: a) an indicator, e.g., low, medium, high, implying the maximum complexity or maximum size or maximum computation power of the AI model that is supported by the UE; b) the maximum FLOPS that is supported by the UE; c) inference latency achieved by the UE when using a reference AI model (or a default AI model); or d) the maximum number of AI models that the UE can store. Information on capabilities related to one or more specific AI based positioning methods may include a processing capability related to reference signals, e.g., at least one of the following: band(s) supported by the UE; frequency(s) supported by the UE; bandwidth(s) supported by the UE; the maximum number of frequency layers supported by the UE; or the maximum number of reference signals processed by the UE in a slot.

The UE may transmit the first message on its own initiative. For example, in some scenarios, sufficient measurements have been collected and stored in the UE already. If the UE has ascertained that the amount positioning measurements collected can be used as inputs into an AI model, then the UE may decide to request an AI model for UE location estimation. The UE may transmit a general indicator to the LMF, e.g., a location service request message or a message indicating UE's support of AI based positioning estimation to the LMF. The LMF may decide to transfer an AI model to the UE for UE location estimation in some other scenarios. In such scenarios, the first message is the location service request message or the message indicating UE's support of AI based positioning estimation from the UE.

In some other embodiments of the present application, the first message is transmitted in response to reception of another message from the LMF or other apparatus. For example, similar to the above, the UE may transmit a general indicator to the LMF, e.g., a location service request message or a message indicating UE's support of AI based positioning estimation to the LMF. The LMF may trigger a capability transfer procedure to further understand the UE's capability to support AI based positioning rather than directly deciding to transfer an AI model to the UE for UE location estimation. In some other scenarios, the LMF may trigger the capability transfer procedure for other reasons, and the message indicating UE's support of AI based positioning estimation or the like from the UE is not essential. In the capability transfer procedure triggered by the LMF, the LMF may request the UE to provide the AI capability of the UE by sending an LPP message of RequestCapabilities to the UE. In response to the request, the UE will transmit information on its AI capability to the LMF, e.g., an LPP message of ProvideCapabilities. In such a capability transfer procedure triggered by the LMF, the first message may be the LPP message of Provide Capabilities in response to the LPP message of RequestCapabilities.

In step 302, the LMF will receive the first message from the UE, e.g., via a NAS message or an LPP message. The LMF will provide a UE location estimation response to the UE in response to the first message in step 304, e.g., transmitting a second message to the UE in response to the first message. In some scenarios, the LMF may determine whether an AI model for UE location estimation will be transferred to the UE based on the information of the UE, e.g., based on UE's capability to support AI based positioning provided in the first message or other message(s). In the case that the LMF determines that an AI model for UE location estimation can be transferred to the UE, the LMF will transmit the second message at least includes information for determining an AI model for UE position estimation to the UE. In some other scenarios, the LMF may directly transmit the second message to the UE in response to reception of the first message.

In the case that the LMF determines that the UE is capable of AI based UE location estimation, the second message will at least include information for determining an AI model for UE position estimation. The LMF will transmit the determined AI model to the UE in step 306. Consequently, the UE will receive the second message from the LMF in step 305, and receive the AI model from the LMF in step 307. Transfer of AI model from the LMF to the UE means transmitting AI model from the perspective of the LMF side and receiving AI model from the perspective of the UE side. Exemplary AI model transfer includes transfer of the payload of the AI model, downloading the AI model from the URL or FQDN owned by the LMF via user plane protocol, and/or transfer of essential assistance data, e.g. information related to the AI model validity, which may concern different parameters, e.g., concerning on area or period etc. Exemplary AI model transfer may also include transfer other information related to the AI model except for the above.

In some other embodiments of the present application, the LMF may transmit the second message to the UE for other reasons rather than receiving the first message from the UE. For example, similar to step 201a illustrated in FIG. 2, some 5GC LGS entities may transmit a first message to request some location services (e.g. positioning) from the LMF for a target UE, e.g., a location service via the serving AMF. Similar to step 201b illustrated in FIG. 2, the serving AMF for a target UE may determine the need for some location services (e.g. to locate the UE for an emergency call), and then transmit a first message, e.g., a location service request to the LMF. After receiving the first message, the LMF will transmit the second message at least including the information for determining an AI model for UE position estimation.

The information for determining an AI model for UE position estimation may include information related to AI model transfer. Exemplary information related to AI model transfer may indicate at least one of the following: a) URL owned by the LMF or FQDN owned by the LMF, from that the AI model will be downloaded, which can be coded as a OCTET string; b) type of learning method used by the AI model, e.g., unsupervised or supervised learning, clustering, classification, dimension reduction, regression etc.; c) type of the AI model, e.g., deep neural network, support vector machine (SVM), k-nearest neighbor (KNN) classifier or the like; d) parameters related to the AI model (instead of the full payload of the AI model), e.g., neural network weights, the number of layers, support vector (for SVM), and coefficients for linear or logistic regression etc.; e) full payload of the AI model; or f) ID of the AI model.

In some embodiments of the present application, the LMF may further transmit information related to AI model application to the UE. Part or all of the information related to AI model application to the UE may be collected by the LMF from relevant BSs, e.g., gNBs, e.g., via NR positioning protocol A (NRPPa) procedure or by other manners. The information related to AI model application can be transmitted (or received in the perspective of UE side) before the AI model is downloaded from the LMF or is transmitted (or received in the perspective of UE side) after the AI model is downloaded from the LMF. For example, in the case that the information related to AI model application is received by the UE before the AI model is downloaded from the LMF, the information related to AI model application may also be included in the second message.

Exemplary information related to AI model application may include information related to reference signals that will be measured and measurement results will be used as inputs to the AI model. An exemplary reference signal may be positioning reference signal (PRS), and the information related to the reference signaling may be frequency layer, transmit-receive point (TRP) identity (ID), PRS resource set ID, PRS resource ID and relevant cell ID in terms of physical cell identity (PCI) or NR cell global identity (NCGI), or absolute radio frequency channel number (ARFCN) etc. Another exemplary reference signal may be synchronization signal (SS) and physical channel (PBCH) block (SSB), and the information related to the reference signaling may be SSB Index and relevant cell ID. Yet another exemplary reference signal may be channel state information reference signal (CSI-RS), and the information related to AI model validity concerning reference signals may be CSI-RS index and relevant cell ID.

In some other embodiments of the present application, the information related to AI model application may include information related to AI model validity concerning reference signals, which may indicate one or more reference signals that must be detected and/or the relevant RSRP or other measurement results must be above a threshold. For example, in the case that the reference signals that will be measured are configured, the information related to AI model application may include information related to AI model validity concerning reference signals, e.g., information of determining whether the AI model is valid or not. The information of determining whether the AI model is valid or not may include at least one of the following: a) at least one indicator, wherein each indicator is associated with a reference signal and indicates whether the reference signal needs to be detected; or b) at least one threshold, each threshold is that measured RSRP of one or more associated reference signals needs to be above or equal to. For example, each reference signal is provided with a threshold, or multiple reference signals are provided with the same threshold.

An example of information related to AI model application is shown below, wherein the information related to reference signals that will be measured and measurement results will be used as inputs to the AI model and the information related to AI model validity concerning reference signals are included.

NR-DL-AI-RS-AssistanceData-r18 ::= SEQUENCE {

| | |
|---|---|
| nr-DL-AI-RS-AssistanceDataList-r18 | SEQUENCE (SIZE (1..nrMaxFreqLayers-r18)) OF |

NR-DL-AI-RS-

```
AssistanceDataPerFreq-r18,
  ...
}
NR-DL-AI-RS-AssistanceDataPerFreq-r18 ::= SEQUENCE {
  nr-DL-AI-RS-PositioningFrequencyLayer-r18
```

NR-DL-AI-RS-PositioningFrequencyLayer-r18,

nr-DL-AI-RS-AssistanceDataPerFreq-r18 SEQUENCE (SIZE (1..nrMaxTRPsPerFreq-r18))
OF

NR-DL-AI-RS-

```
AssistanceDataPerTRP-r18,
  ...
}
NR-DL-AI-RS-AssistanceDataPerTRP-r18 ::= SEQUENCE {
  NR-DL-PRS-AssistanceDataPerTRP-r16
  NR-DL-SSB-AssistanceDataPerTRP-r18
  NR-DL-CSIRS-AssistanceDataPerTRP-r18
}
NR-DL-PRS-AssistanceDataPerTRP-r16 ::= SEQUENCE {
```

| dl-PRS-ID-r16 | INTEGER (0..255), | |
|---|---|---|
| nr-PhysCellID-r16 | NR-PhysCellID-r16 | OPTIONAL, -- Need ON |
| nr-CellGlobalID-r16 | NCGI-r15 | OPTIONAL, -- |

Need ON

| | | |
|---|---|---|
| nr-ARFCN-r16 | ARFCN-ValueNR-r15 | OPTIONAL, -- |

Need ON

| | |
|---|---|
| nr-DL-PRS-SFN0-Offset-r16 | NR-DL-PRS-SFN0-Offset-r16, |
| nr-DL-PRS-ExpectedRSTD-r16 | INTEGER (−3841..3841), |

nr-DL-PRS-ExpectedRSTD-Uncertainty-r16

| | |
|---|---|
| | INTEGER (0..246), |
| nr-DL-PRS-Info-r16 | NR-DL-PRS-Info-r16, |

```
  ...,
  [[
```

| | | |
|---|---|---|
| prs-OnlyTP-r16 | ENUMERATED { true } | OPTIONAL -- Need |

```
ON
  ]],
  [[
    nr-DL-PRS-ExpectedAoD-or-AoA-r17
```

NR-DL-PRS-ExpectedAoD-or-AoA-r17 OPTIONAL

```
  -- Need ON
  ]]
  [[
```

| | | |
|---|---|---|
| AIModelValidityThreshold-r18 | INTEGER (xxx..xxx) | OPTIONAL, |

]]
}

According to the exemplary information related to AI model application, PRS, SSB and CSI-RS are configured, which will be measured and measurement results will be used as inputs to the AI model. In addition, an indicator associated with the PRS and a corresponding threshold is provided, which indicates that PRS needs to be detected; and the RSRP of the detected RSRP should be above or equal to the threshold. Otherwise, the AI model will not be valid for UE location estimation.

In other words, in terms of AI model, e.g., fingerprinting, depending on the AI model, the UE may use the measured RSRP of saying 100 reference signals (not only PRS, but also SSB and CSI-RS) as inputs. While among those input signals, some will be essential that only when they can be detected or when they are good enough (e.g., the UE is near a TRP), the estimated UE location or position by the AI model is considered accurate or valid.

In some yet other embodiments of the present application, the information related to AI model application may include information related to AI model validity concerning area, e.g., area(s) defined in a list of cells. For example, the information related to AI model validity concerning area may indicate that the UE can use the AI model only if the UE is connected to at least one of the provided cells.

In some yet other embodiments of the present application, the information related to AI model application may include information related to AI model validity concerning validity period, e.g., a period during which the measured reference signals can be applicable to the AI model. The information related to AI model validity concerning validity period can be expressed using different manners. For example, the information related to AI model validity concerning validity period may indicate a validity duration in unit of “ms,” “s,” “minute” or the like. In another example, the information related to AI model validity concerning validity period may indicate an absolute time, e.g., universal time coordinated (UTC) time, when the provided assistance data for the AI model is considered to be expired or not applicable to the AI model.

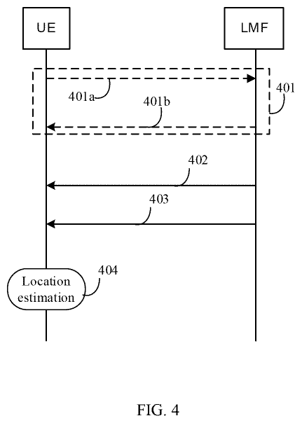

Some more specific embodiments are illustrated in view of FIGS. 4 and 5, wherein the information related to AI application is received before the AI model for UE location estimation is downloaded from the LMF by the UE in FIG. 4, and the information related to AI application is received after the AI model for UE location estimation is downloaded from the LMF by the UE.

First, regarding FIG. 4, it illustrates an exemplary procedure of a method of UE location estimation according to some embodiments of the present application.

As shown in FIG. 4, in step 401, the UE may transmit a first message to the LMF as illustrated in FIG. 3. The first message may be a NAS message, e.g., a Location Service Request to the LMF via the AMF in step 401a, or an LPP message, e.g., a RequestAssistanceData message in step 401b. In some embodiments of the present application, the UE may transmit both the two messages to the LMF.

In step 402, the LMF may transmit a second message to the UE in response to the first message. For example, the second message may be an LPP message, e.g., Provide Assistance Data message, including an information element (IE). The IE may be a new IE compared with the legacy, and may contain only the information related to AI model transfer, or both of the information related to AI model transfer and the information related to AI model application. In the case that the second message does not include the information related to AI model application, the LMF may transmit the information related to AI model application to the UE in another message separate from the second message before the UE starts to download the AI model from the LMF.

After receiving the information related to AI model transfer (e.g., ID of the AI model, and URL or FQDN where the AI model can be downloaded) and the information related to AI model application, the UE will start to download the AI model based on the information related to AI model transfer via the user plane protocol in step 403, e.g., from the provided URL or FQDN.

After downloading the AI model (the downloading is finished), the UE will apply the relevant assistance data to the AI model and start UE location estimation in step 404.

Regarding FIG. 5, it illustrates an exemplary procedure of a method of UE location estimation according to some other embodiments of the present application.

As shown in FIG. 5, in step 501, the UE may transmit a first message to the LMF as illustrated in FIG. 3. The first message may be a NAS message, e.g., a Location Service Request to the LMF via the AMF in step 501a, or an LPP message, e.g., a RequestAssistanceData message in step 501b. In some embodiments of the present application, the UE may transmit both the two messages to the LMF.

In step 502, the LMF may transmit a second message to the UE in response to the first message. For example, the second message may be an LPP message, e.g., Provide Assistance Data message, including only the information related to AI model transfer, e.g., ID of the AI model, and URL or FQDN where the AI model can be downloaded.

After receiving the information related to AI model transfer, the UE will start to download the AI model based on the information related to AI model transfer via the user plane protocol in step 503, e.g., from the provided URL or FQDN.

After downloading the AI model, the UE will transmit another message to the LMF to request the information related to AI application, e.g., AI model relevant assistance data in step 504. For example, the UE may transmit another LLP message, e.g., another RequestAssistanceData message, including the AI model ID or other information that can identify the downloaded AI model. After receiving the request, the LMF will transmit the information related to AI application of the AI model to the UE in step 505. In another example, the UE may transmit another LPP message specifically for the request AI positioning information or response AI positioning information, e.g., RequestAIMLAssistance Data to request the information related to AI application or in response to the second message, e.g., which may contain acknowledgement (ACK) or non-acknowledgement (NACK) indicating that the AI model has been successfully download or not besides the AI model ID. In the case that the AI model has not been successfully downloaded, an indicator may also be transmitted to the network (e.g., the LMF) to indicate whether the AI model has been partially downloaded (e.g., can be indicated via a flag or the ratio of the downloaded AI payload over the total size of the AI payload). In the case that the AI model has been downloaded, the LMF will transmit the information related to AI application to the UE in step 505. In some other embodiments of the present application, regardless of whether there is a relevant message, e.g., the request or ACK from the UE (step 504 is not essential), the LMF may determine whether the UE has downloaded the AI model or not (whether the downloading is finished). In the case that the LMF determines that the UE has downloaded the AI model, the LMF will transmit the information related to AI application to the UE. The information related to AI application can be collected before receiving the request or the like message in some scenarios. While in some other scenarios, the LMF will start to collect the information related to AI application from the relevant gNBs only after receiving the request or the like message.

After receiving the information related to AI application, the UE will apply the relevant assistance data to the AI model and start UE location estimation in step 506.

During an AI model transfer procedure, some problems may occur. In response to at least one problem detected in the UE during the AI model transfer procedure, the UE may report the corresponding cause(s) to the LMF, e.g., by sending an LPP Abort message or Error message to the LMF. For example, a cause may be an AI model download error, e.g., indicating that the AI model downloading fails. In another example, a cause may be an AI model compliance error, e.g., indicating that the given AI model cannot be adopted by the UE. In yet another example, a cause may be an AI model validity error, e.g., indicating that the model validity criteria is not met. An exemplary scenario that the model validity criteria is not met may be that the UE moves out of the validity area, or the fundamental reference signals (the reference signals configured to be measured) are not detected, or expiry of AI/ML model validity timer. Such a timer may be configured by the network (e.g., LMF) to indicate the validity duration of the AI model.

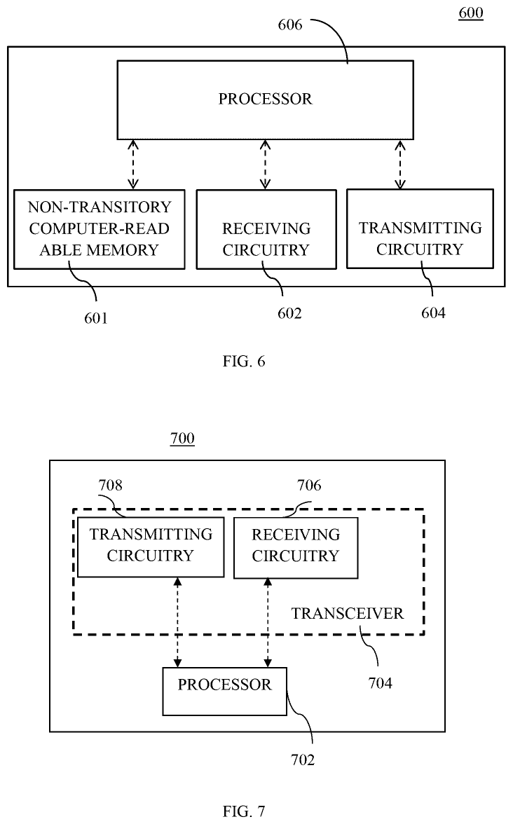

Besides methods of UE location estimation, some embodiments of the present application also provide an apparatus of UE location estimation. For example, FIG. 6 illustrates a block diagram of an apparatus of UE location estimation 600 according to some embodiments of the present application.

As shown in FIG. 6, the apparatus 600 may include at least one non-transitory computer-readable medium 601, at least one receiving circuitry 602, at least one transmitting circuitry 604, and at least one processor 606 coupled to the non-transitory computer-readable medium 601, the receiving circuitry 602 and the transmitting circuitry 604. The at least one processor 606 may be a CPU, a DSP, a microprocessor etc. The apparatus 600 may be a RAN node configured to perform a method illustrated in the above or the like.

Although in this figure, elements such as the at least one processor 606, transmitting circuitry 604, and receiving circuitry 602 are described in the singular, the plural is contemplated unless a limitation to the singular is explicitly stated. In some embodiments of the present application, the receiving circuitry 602 and the transmitting circuitry 604 can be combined into a single device, such as a transceiver. In certain embodiments of the present application, the apparatus 600 may further include an input device, a memory, and/or other components.

In some embodiments of the present application, the non-transitory computer-readable medium 601 may have stored thereon computer-executable instructions to cause a processor to implement the method with respect to a remote apparatus, e.g., a UE as described above. For example, the computer-executable instructions, when executed, cause the processor 606 interacting with receiving circuitry 602 and transmitting circuitry 604, so as to perform the steps with respect to a remote apparatus as depicted above, e.g., shown in FIG. 3.

In some embodiments of the present application, the non-transitory computer-readable medium 601 may have stored thereon computer-executable instructions to cause a processor to implement the method with respect to a CN node, e.g., an LMF as described above. For example, the computer-executable instructions, when executed, cause the processor 606 interacting with receiving circuitry 602 and transmitting circuitry 604, so as to perform the steps with respect to a CN node as depicted above, e.g., shown in FIG. 3.

FIG. 7 is a block diagram of an apparatus of UE location estimation 700 according to some other embodiments of the present application.

Referring to FIG. 7, the apparatus 700, for example a UE or an LMF may include at least one processor 702 and at least one transceiver 704 coupled to the at least one processor 702. The transceiver 704 may include at least one separate receiving circuitry 706 and transmitting circuitry 708, or at least one integrated receiving circuitry 706 and transmitting circuitry 708. The at least one processor 702 may be a CPU, a DSP, a microprocessor etc.

According to some embodiments of the present application, when the apparatus 700 is a remote apparatus, e.g., a UE. The UE includes a processor, and a transceiver coupled to the processor, wherein the transceiver is configured to: send a first message to an LMF associated with one or more BSs, e.g., one or more gNBs of a wireless network; receive a second message from the LMF in response to sending the first message, wherein the second message at least includes information for determining an AI model for UE position estimation; and receive the AI model as determined from the LMF.

According to some other embodiments of the present application, when the apparatus 700 is a CN node, e.g., an LMF. The LMF includes a processor, and a transceiver coupled to the processor, wherein the transceiver is configured to: receive a first message to an LMF associated with one or more BSs, e.g., one or more gNBs of a wireless network; transmit a second message from the LMF in response to sending the first message, wherein the second message at least includes information for determining an AI model for UE position estimation; and transmit the AI model as determined from the LMF.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE) for wireless communication, comprising:
at least one memory; and
at least one processor coupled with the at least one memory and configured to cause the UE to:
send a first message to a location management function (LMF) associated with one or more base stations (BSs) of a wireless network;
receive a second message from the LMF in response to sending the first message, wherein the second message at least includes information for determining an artificial intelligence (AI) model for UE position estimation; and
receive the determined AI model from the LMF.

2. The UE of claim 1, wherein the first message indicates at least one of the following:
a target scenario;
a preferred positioning method; or
an AI capability of the UE.

3. The UE of claim 1, wherein the information for determining an AI model for UE position estimation comprises information related to an AI model transfer, and the information related to the AI model transfer indicates at least one of the following:
a uniform resource location (URL) owned by the LMF or a fully qualified domain name (FQDN) owned by the LMF, from which the AI model will be downloaded;
a type of learning method used by the AI model;
a type of the AI model;
parameters related to the AI model;
a full payload of the AI model; or
an identity of the AI model.

4. The UE of claim 1, wherein the at least one processor is further configured to cause the UE to receive information related to an AI model application, and wherein the information related to the AI model application comprises:
information related to reference signals to be measured and measurement results to be used as inputs to the AI model;
information related to an AI model validity concerning reference signals;
information related to an AI model validity concerning area; or
information related to an AI model validity concerning validity period.

5. The UE of claim 4, wherein, when the reference signals to be measured are configured, the information related to the AI model application comprises information for determining whether the AI model is valid or not, and wherein the information for determining whether the AI model is valid or not comprises:
at least one indicator, wherein the at least one indicator is associated with a reference signal and indicates whether the reference signal needs to be detected; or
at least one threshold, wherein the at least one threshold is a measured reference signal receiving power (RSRP), and wherein one or more associated reference signals are above or equal to the RSRP.

6. The UE of claim 4, wherein, the information related to the AI model application is received before the AI model is downloaded from the LMF or is received after the AI model is downloaded from the LMF.

7. The UE of claim 6, wherein, when the information related to the AI model application is received before the AI model is downloaded from the LMF, and wherein the information related to the AI model application is also included in the second message.

8. The UE of claim 6, wherein, when the information related to the AI model application is received after the AI model is downloaded from the LMF, the at least one processor is further configured to cause the UE to transmit a message to request the information related to AI model application after downloading the AI model.

9. The UE of claim 1, wherein, in response to at least one problem detected during an AI model transfer procedure, the at least one processor is further configured to cause the UE to report at least one cause to the LMF, including:
an AI model download error;
an AI model compliance error; or
an AI model validity error.

10. The UE of claim 1, wherein the at least one processor is further configured to cause the UE to transmit to the LMF:
information on common capabilities related to AI based positioning; or
information on capabilities related to one or more specific AI based positioning methods.

11. The UE of claim 10, wherein the information on common capabilities related to AI based positioning comprises:
an indicator implying maximum complexity or maximum size or maximum computation power of the AI model that is supported by the UE;
a maximum floating-point operations per second (FLOPS) that is supported by the UE;
an inference latency achieved by the UE when using a reference AI model; or
a maximum number of AI models that the UE can store.

12. The UE of claim 10, wherein the information on capabilities related to one or more specific AI based positioning methods comprises:
bands supported by the UE;
frequencies supported by the UE;
bandwidths supported by the UE;
a maximum number of frequency layers supported by the UE; or
a maximum number of reference signals processed by the UE in a slot.

13. The UE of claim 3, wherein receiving the AI model from the LMF comprises downloading the AI model from the URL or the FQDN via a user plane protocol.

14. A location management function (LMF) for wireless communication, comprising:
at least one memory; and
at least one processor coupled with the at least one memory and configured to cause the LMF to:
receive a first message from a user equipment (UE);
transmit a second message to the UE in response to receiving the first message, wherein the second message at least includes information for determining an artificial intelligence (AI) model for UE position estimation; and
transmit the determined AI model to the UE.

15. A method performed by a user equipment (UE), the method comprising:
sending a first message to a location management function (LMF) associated with one or more base stations (BSs) of a wireless network;
receiving a second message from the LMF in response to sending the first message, wherein the second message at least includes information for determining an artificial intelligence (AI) model for UE position estimation; and
receiving the determined AI model from the LMF.

16. A processor for wireless communication, comprising:
at least one controller coupled with the at least one memory and configured to cause the processor to:
send a first message to a location management function (LMF) associated with one or more base stations (BSs) of a wireless network;
receive a second message from the LMF in response to sending the first message, wherein the second message at least includes information for determining an artificial intelligence (AI) model for UE position estimation; and
receive the determined AI model from the LMF.

17. The processor of claim 16, wherein the first message indicates at least one of the following:
a target scenario;
a preferred positioning method; or
an AI capability of the processor.

18. The processor of claim 16, wherein the information for determining an AI model for UE position estimation comprises information related to an AI model transfer, and the information related to the AI model transfer indicates at least one of the following:
a uniform resource location (URL) owned by the LMF or a fully qualified domain name (FQDN) owned by the LMF, from which the AI model will be downloaded;
a type of learning method used by the AI model;
a type of the AI model;
parameters related to the AI model;
a full payload of the AI model; or
an identity of the AI model.

19. The processor of claim 16, wherein the at least one controller is further configured to cause the processor to receive information related to an AI model application, and wherein the information related to the AI model application comprises:
information related to reference signals to be measured and measurement results to be used as inputs to the AI model;
information related to an AI model validity concerning reference signals;
information related to an AI model validity concerning area; or
information related to an AI model validity concerning validity period.

20. The processor of claim 16, wherein the at least one controller is further configured to cause the processor to transmit to the LMF:
information on common capabilities related to AI based positioning; or
information on capabilities related to one or more specific AI based positioning methods.
